(19) United States
(12) Patent Application Publication
(10) Pub. No.: US 2008/0315983 A1
(43) Pub. Date: Dec. 25, 2008

(54) Safety Device For Preventing Propagation in Fracture of Ceramic Element

(76) Inventors: Byoung-Koo Oh, Chungbuk (KR); Man-Sik Lee, Chungbuk (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/995,415

(22) PCT Filed: Jun. 16, 2006
(86) PCT No.: PCT/KR06/02310

§ 371 Date: Jul. 26, 2008

(30) Foreign Application Priority Data
Jul. 11, 2005 (KR) 10-2005-0062130
Jul. 19, 2005 (KR) 20-2005-0020930

(51) Int. Cl. H01H 71/00

(52) U.S. Cl. 337/14

(57) ABSTRACT

The present invention relates to a safety device for preventing propagation when a ceramic element is failed. An angle is formed such that elastic terminals contacted at both faces of the ceramic element do not face each other and an elastic terminal of one lateral face of the ceramic element is formed without one leg so as not to be contacted with the ceramic element, and therefore when an unsustainable force is applied to the ceramic element by an excessive thermal stress or an excessive current caused by an external abnormal power supply is applied to the ceramic element, the ceramic element performs an immediate failure and thus a rapid cut-off capability of circuit. The upper case is provided with a receiving space for accommodating a ceramic element such that the ceramic element remains upright inside of the receiving space, or the ceramic element is mounted inside of an insulator such that the insulator supports an off-set force by a connection force of the elastic terminal to allow the ceramic element to remain upright. A wedge is formed integrally with the upper case so as to be contacted with the elastic terminal mounted at both sides of the upper case, which supports the elastic terminal, thereby supporting the elastic terminal. Even after the operation of the safety device, the scattered ceramic element is captured by the wall face of the receiving space inside of the upper case, thereby providing a capability of stable circuit cut-off. A case protrusion is formed at both lower portions of the upper case to which the ceramic element is mounted, thereby providing a gradient to allow the ceramic element to remain upright. The tab terminal and the elastic terminal are connected by means of a rivet or welding, and the elastic terminal is provided with an embossing to reinforce the elasticity of the elastic terminal material, thereby enabling to be replaced by a thinner elastic terminal and thus reduce the manufacturing cost.

### TECHNICAL FIELD

The present invention relates to a safety device for preventing propagation when a ceramic element is failed. More specifically, the invention relates to a safety device for preventing propagation when a ceramic element is failed, in which an angle is formed such that elastic terminals contacted at both faces of the ceramic element do not face each other and an elastic terminal of one lateral face of the ceramic element is formed without one leg so as not to be contacted with the ceramic element, and therefore when an unsustainable force is applied to the ceramic element by an excessive thermal stress or an excessive current caused by an external abnormal power supply is applied to the ceramic element, the ceramic element performs an immediate failure and thus a rapid cut-off capability of circuit. The invention relates to a safety device for preventing propagation when a ceramic element is failed, in which the upper case is provided with a receiving space for accommodating a ceramic element such that the ceramic element remains upright inside of the receiving space, or the ceramic element is mounted inside of an insulator such that the insulator supports an off-set force by a connection force of the elastic terminal to allow the ceramic element to remain upright. The invention relates to a safety device for preventing propagation when a ceramic element is failed, in which a wedge is formed integrally with the upper case so as to be contacted with the elastic terminal mounted at both sides of the upper case, which supports the elastic terminal, thereby supporting the elastic terminal. The invention relates to a safety device for preventing propagation when a ceramic element is failed, in which, even after the operation of the safety device, the scattered ceramic element is captured by the wall face of the receiving space inside of the upper case, thereby providing a capability of stable circuit cut-off. The invention relates to a safety device for preventing propagation when a ceramic element is failed, in which a case protrusion is formed at both lower portions of the upper case to which the ceramic element is mounted, thereby providing a gradient to allow the ceramic element to remain upright. The invention relates to a safety device for preventing propagation when a ceramic element is failed, in which the tab terminal and the elastic terminal are connected by means of a rivet or welding, and the elastic terminal is provided with an embossing to reinforce the elasticity of the elastic terminal material, thereby enabling to be replaced by a thinner elastic terminal and thus reduce the manufacturing cost.

### BACKGROUND ART

In general, a non-contact starter relay, PTC, is mounted on the compressor of refrigerators or air-conditioner to function to start them. In case where an abnormal voltage or abnormal current or a thermal stress is applied to the PTC, the PTC leads to its failure. At this time, if the current is continuously flown in, secondary and third fractures occur to lead to melting of the surrounding insulation case, along with complete loss of the PTC, thereby resulting in occurrence of contaminants and fire. The PTC (positive temperature coefficient thermistor) generates heat by joule heat when electricity is applied thereto. The PTC is a safe heat-emitter replacing Nichrome wire and has a property that, if an excessive current is applied for an extremely short period of time, its electrical resistance increases spontaneously to cut off the current. Thus, the PTC is employed as an element in the shadow mask of television, a car pre-heater, an electric heater, a leisure warm air blower, a home bidet, a hot water supplier, an air conditioner, a refrigerator, an auxiliary heat, and the like. From everyday life, a hair drier, a clothes-drier and the like employ the positive temperature coefficient thermistor.

However, the conventional PTC for motor starting may experience fracture under an environment such as thermal stress or abnormal voltage. When the power is repeatedly applied, the fracture propagates into secondary and third fractures. At this time, the PTC element between the facing terminals at both ends of the PTC device is connected through a circuitry and thus a complete failure of the PTC element occurs. In order to prevent the continual fracture, the conventional safety modes are disclosed in Korean Patent Laid-Open Publication No. 1997-77379, Korean Utility Model Laid-Open Publication No. 1998-26187 and Korean Patent Laid-Open Publication No. 2001-29532. In the disclosed safety modes, the instrumental cut-off is performed through symmetry of terminals. However, by the inherent properties of the PTC thermistor, an irregular fracture occurs to thereby causes problems of a lower success rate of the safety mode and a delay in the operating time as a safety mode. Thus, due to the above problems, the conventional safety mode leads to a degraded efficiency and thus embraces a problem of minimizing user's satisfaction for the products.

In addition, another form of the safety mode is disclosed in U.S. Pat. No. 6,407,659. This safety mode is structured such that the PTC element is touched to part of the upper case, and thus a separate material having a heat-resistance must be used and a tab base must be used for a design of off-set terminals. That is, additional design and terminal are needed disadvantageously. The spring terminal is not provided with an embossing treatment so that a thicker material must be used to ensure a desired elastic strength. In order for the PTC element to be arranged along a diagonal line, it is supported not to move into the facing first and second elastic contact points. Also, in order to be arranged along another diagonal line, it is supported not to move into the opposing first and second protrusions. The first elastic contact point is positioned towards the outer periphery of the PTC from the second protrusion, and the second elastic contact point is positioned towards the inner portion of the PTC from the first protrusion. Thus, disadvantageously the assembling procedures are complicated and include a lot of assembling steps, thus leading to degradation in assembling characteristic.

Therefore, there is a need for a safety device, in which, when an unsustainable force is applied to the ceramic element by an excessive thermal stress or an excessive current caused by an external abnormal power supply is applied to the ceramic element, the ceramic element performs an immediate failure and thus a rapid cut-off capability of circuit; the insulator supports an off-set force by a connection force of the elastic terminal to allow the ceramic element to remain upright; the elastic terminal is supported; a case protrusion is formed at both lower portions of the upper case to which the ceramic element is mounted, thereby providing a gradient to allow the ceramic element to remain upright; the elasticity of the elastic terminal material is reinforced, thereby enabling to be replaced by a thinner elastic terminal and thus reduce the manufacturing cost; and even after the operation of the safety device, the scattered ceramic element is captured by the wall face of the receiving space inside of the upper case, thereby providing a capability of stable circuit cut-off.

### DISCLOSURE OF INVENTION

### Technical Problem

Accordingly, the present invention has been made in order to solve the above problems, and it is an object of the invention to provide a safety device for preventing propagation when a ceramic element is failed, in which an angle is formed such that elastic terminals contacted at both faces of the ceramic element do not face each other and an elastic terminal of one lateral face of the ceramic element is formed without one leg so as not to be contacted with the ceramic element, and therefore when an un-sustainable force is applied to the ceramic element by an excessive thermal stress or an excessive current caused by an external abnormal power supply is applied to the ceramic element, the ceramic element performs an immediate failure and thus a rapid cut-off capability of circuit.

Another object of the invention is to provide a safety device for preventing propagation when a ceramic element is failed, in which the upper case is provided with a receiving space for accommodating a ceramic element such that the ceramic element remains upright inside of the receiving space, or the ceramic element is mounted inside of an insulator such that the insulator supports an off-set force by a connection force of the elastic terminal to allow the ceramic element to remain upright.

Still another object of the invention is to provide a safety device for preventing propagation when a ceramic element is failed, in which a wedge is formed integrally with the upper case so as to be contacted with the elastic terminal mounted at both sides of the upper case, which supports the elastic terminal, thereby supporting the elastic terminal.

Yet another object of the invention is to provide a safety device for preventing propagation when a ceramic element is failed, in which, even after the operation of the safety device, the scattered ceramic element is captured by the wall face of the receiving space inside of the upper case, thereby providing a capability of stable circuit cut-off.

A further object of the invention is to provide a safety device for preventing propagation when a ceramic element is failed, in which a case protrusion is formed at both lower portions of the upper case to which the ceramic element is mounted, thereby providing a gradient to allow the ceramic element to remain upright.

A still further object of the invention is to provide a safety device for preventing propagation when a ceramic element is failed, in which the tab terminal and the elastic terminal are connected by means of a rivet or welding, and the elastic terminal is provided with an embossing to reinforce the elasticity of the elastic terminal material, thereby enabling to be replaced by a thinner elastic terminal and thus reduce the manufacturing cost.

### BRIEF DESCRIPTION OF THE DRAWINGS

Further objects and advantages of the invention can be more fully understood from the following detailed description taken in conjunction with the accompanying drawings in which:

FIG. 1 is a perspective view showing the appearance of a safety device according to an embodiment of the invention;

FIG. 2 is a perspective view showing an upper case constituting the safety device according to an embodiment of the invention where an elastic terminal, a ceramic element and a tab terminal are mounted;

FIG. 3 is a perspective view showing a lower case constituting a safety device according to another embodiment of the invention where an elastic terminal, an insulator, a ceramic element, and a tab terminal are mounted;

FIG. 4 is a perspective view showing a safety device according to an embodiment of the invention where an upper case is combined with a lower case;

FIG. 5 is a perspective view of an insulator constituting a safety device according to an embodiment of the invention;

FIG. 6 is a perspective view showing the connection of an elastic terminal and a tab terminal in a safety device according to an embodiment of the invention;

FIG. 7 is a perspective view of a tab terminal constituting a safety device according to an embodiment of the invention;

FIG. 8 is a perspective view of an elastic terminal constituting a safety device according to an embodiment of the invention; and

FIG. 9 is a sectional view showing a wedge, a receiving space and a case protrusion formed in a safety device according to an embodiment of the invention.

### MODE FOR THE INVENTION

Hereinafter, the present invention will be described in detail with reference to the accompanying drawings.

In the description of the invention, details on well-known features and techniques may be omitted to avoid unnecessarily obscuring the invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. Thus, such a special definition will be expressly set forth in the specification in a definitional manner that directly and unequivocally provides the special definition for the term or phrase.

To achieve the above objects, the present invention provides a safety device for preventing propagation when a ceramic element is failed, the safety device comprising: an upper case having a wedge integrally formed for being contacted with an elastic terminal and providing a fixed support, the upper case being equipped with a ceramic element, a tap terminal and an elastic terminal and connected with a lower case; a receiving space formed in the center of the upper case and supporting an off-set force by a contact force of the elastic terminal so as to enable the ceramic element to remain upright; a ceramic element mounted inside of the receiving space, wherein, when an unsustainable force is applied by an excessive thermal stress or an excessive current caused by an external abnormal power supply, the ceramic element is derived to be easily fractured, and a conductive material is coated at both faces thereof to form an electrode to which the elastic terminal is contacted, the ceramic element having an exothermic characteristic; an elastic terminal contacted with both faces of the ceramic element and formed so as not to face each other, the elastic terminal being connected with the tap terminal through a rivet or welding to enable the ceramic element to be fractured by an excessive thermal stress or an excessive current; a tab terminal mounted inside of the upper case and connected with the elastic terminal through a rivet or welding to enable to supply power; and a lower case connected with the upper case using a terminal hole, the terminal hole being formed in a position abutting on the tab terminal mounted inside of the upper case.

In addition, the ceramic element includes a positive temperature coefficient thermistor that is heated by application of electricity.

In addition, a receiving space is formed inside of and integrally with the upper case through an injection molding so as to receive the ceramic element at upright state.

In addition, the elastic terminal is formed with an embossing to reinforce the elasticity of elastic terminal material and thus enable to be replaced by a thinner elastic terminal.

In addition, the safety device further comprises a case protrusion formed in the lower end of the lower case, which has a gradient provided such that the ceramic element is inserted and remains upright.

In addition, the safety device further comprises an insulator so as to allow the ceramic element upright.

The preferred embodiments of the invention will be hereafter described in detail with reference to the accompanying drawings.

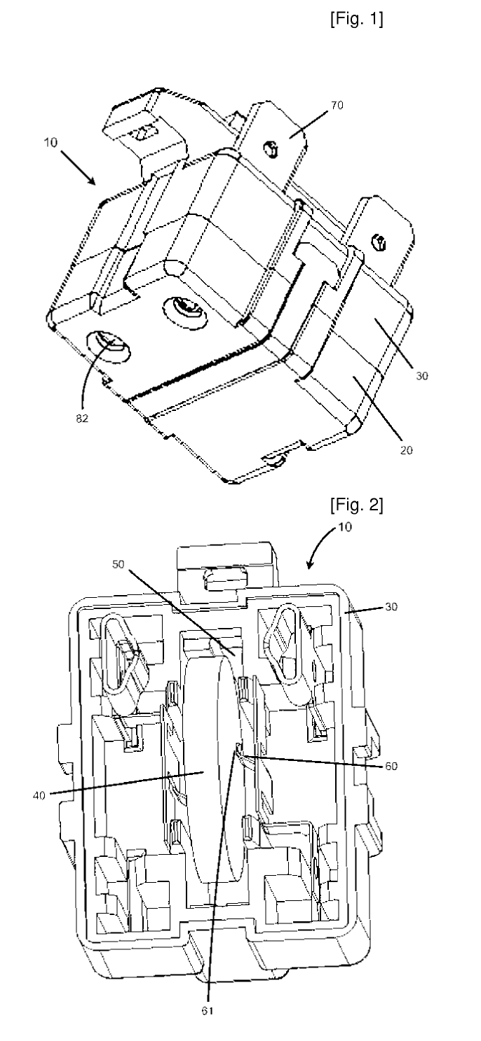

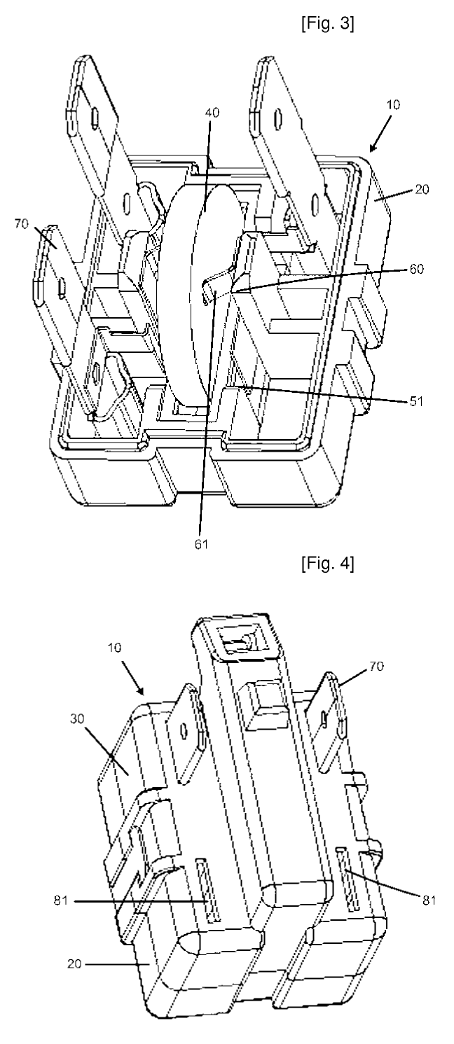

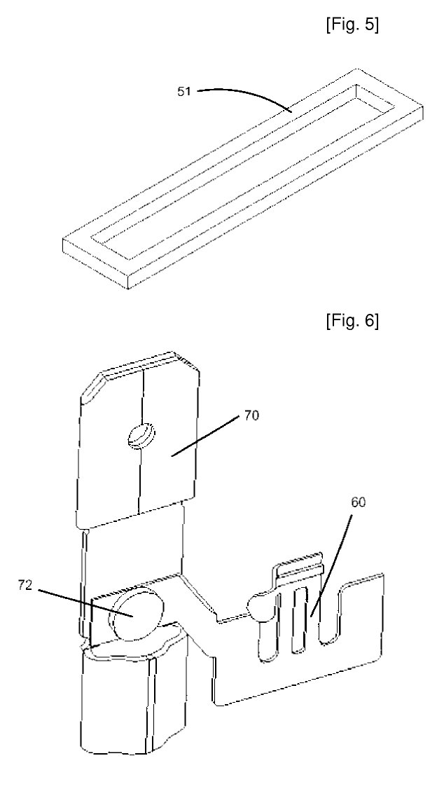

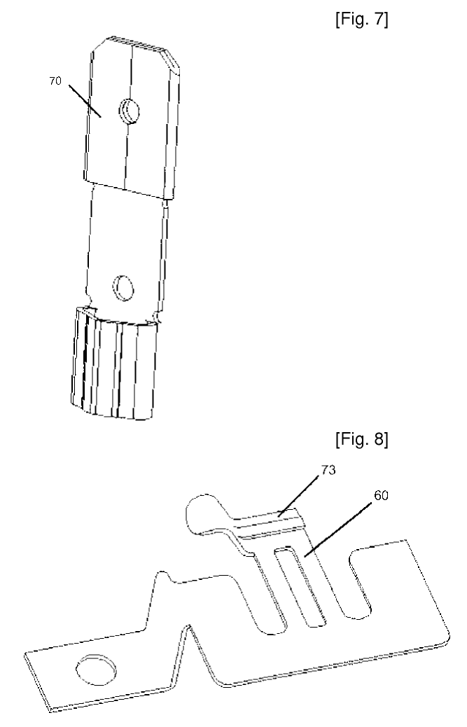

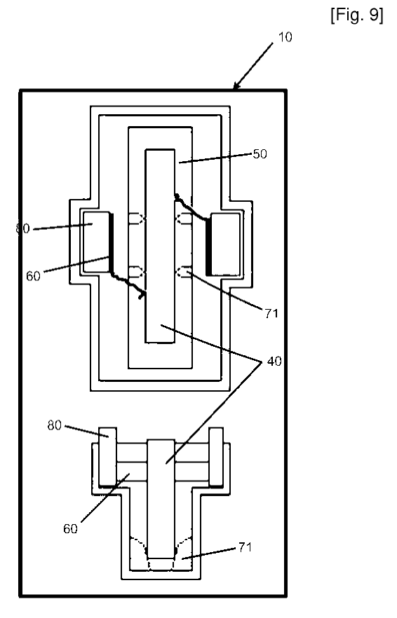

FIG. 1 is a perspective view showing the appearance of a safety device according to an embodiment of the invention. FIG. 2 is a perspective view showing an upper case constituting the safety device according to an embodiment of the invention where an elastic terminal, a ceramic element and a tab terminal are mounted. FIG. 3 is a perspective view showing a lower case constituting a safety device according to another embodiment of the invention where an elastic terminal, an insulator, a ceramic element, and a tab terminal are mounted. FIG. 4 is a perspective view showing a safety device according to an embodiment of the invention where an upper case is combined with a lower case. FIG. 5 is a perspective view of an insulator constituting a safety device according to an embodiment of the invention. FIG. 6 is a perspective view showing the connection of an elastic terminal and a tab terminal in a safety device according to an embodiment of the invention. FIG. 7 is a perspective view of a tab terminal constituting a safety device according to an embodiment of the invention. FIG. 8 is a perspective view of an elastic terminal constituting a safety device according to an embodiment of the invention. FIG. 9 is a sectional view showing a wedge, a receiving space and a case protrusion formed in a safety device according to an embodiment of the invention.

As illustrated in FIGS. 1 to 9, the safety device 10 for preventing propagation during the fracture of a ceramic element is composed of a lower case 20, an upper case 30, a ceramic element 40, a receiving space 50, an insulator 51, an elastic terminal 60, a contact point 61, a tab terminal 70, a case protrusion 71, a rivet 72, an embossing 73, a wedge 80, a groove 81, a terminal hole 82 or the like.

The safety device for preventing propagation during the fracture of a ceramic element is composed of the following technical means.

The lower case 20 is provided with a terminal hole 82 formed at a position where the tab terminal 70 mounted inside the upper case 80 butts. By means of the terminal hole 82, the lower case 20 is connected with the upper case 30. Here, the lower case 20 and the upper case 30 are made of a material endurable at above 150° C.

The upper case 30 is provided with a wedge 80 integrally formed, which is contacted with the elastic terminal 60 and fixedly supports the elastic terminal 60. The upper case 30 is mounted with a ceramic element 40, an insulator 51, a tab terminal 70 and an elastic terminal 60 to thereby be connected with the lower case 20. At this time, if the lower end portion of the upper case 30 is covered with the lower case 20, the wedge 80 of the upper case 30 is inserted by the terminal hole 82 of the lower case 20 formed correspondingly to the wedge 80. At the same time, the lower end portion of the tab terminal 70 connected with the elastic terminal 60 is protruded to outside through a groove 81 of the upper case 30. Due to the above assembling and connection, the contact point 61 of the elastic terminal 60 is electrically connected to both cross-sections of the ceramic element 40 to form a contact point. In addition, a receiving space 50 is integrally formed with the upper case through an injection molding process such that the ceramic element 40 is received inside the upper case and can stand upright. Furthermore, a case protrusion 71 is formed in the lower end of the upper case 20, which is sloped such that the received ceramic element 40 can remain upright.

The ceramic element 40 is mounted inside the insulator. When an excessive thermal stress is applied or an excessive current due to an abnormal external power supply to thereby result in an unsustainable state, the cut-off of the ceramic element is caused.

The ceramic element has an exothermic property such that a conductive material is coated at both end cross-sections to form an electrode to which the elastic terminal is contacted. Here, the ceramic element 40 is a positive temperature coefficient thermistor (PTC), to which electricity is applied to generate heat by means of joule heat. As described above, at the completely assembled and connected state, if an external current is introduced through the lower end portion of the tab terminal 70 that is protruded to outside of the upper case 30 and connected to the outside, the current is flown into the elastic terminal 60 electrically connected with the tab terminal 70 as it is, and the current flown through the elastic terminal 60 is directly flown into the ceramic element 40. Thus, the ceramic element 40, mounted inside the receiving space 50 inside of the upper case of the safety device 10, is heated up.

If a normal operating current flows into the safety device 10, the current flows in a stable fashion. However, when the ceramic element 40 is fractured due to thermal stresses or an excessive current due to an abnormal power supply is introduced, a progressive fracture due to the element fracture occurs secondarily and thirdly. The progressive fracture of the ceramic element 40 results in occurrence of contaminants or fire.

In the present invention to solve the above problems, the elastic terminal 60, mechanically combined with the tab terminal connected to the outside, is mechanically and electrically combined with the ceramic element 40 to form a contact point. At this state, when an abnormal event such as an excessive current flowing occurs, the ceramic element 40 serves as a fuse and thus is fractured. For this purpose, the elastic terminals 60, contacted with both faces of the ceramic element 40, forms a certain angle so as not to face each other. In case where a normal operating current is applied to the elastic terminal 60, a stable current flows. However, if the ceramic element 40 is fractured by means of thermal stress or an excessive current flow by means of an abnormal external power supply, it suffers from an electrical stress. At this time, if the current is beyond an allowed value to which the ceramic element 40 is unsustainable, the ceramic element 40 serves as an instantaneous fuse to result in the failure of the ceramic element.

In this way, if the ceramic element 40 is failed, the short-like excessive current caused by the fracture of the ceramic element 40 or an excessive current flown from the outside is opened to the electric circuit. Thus, no further current flow occurs and no further progressive fracture by the element fracture occurs, thereby enabling to prevent in advance the occurrence of contaminants or fire. In addition, after the operation of the safety device 10, the scattered ceramic element 40 is captured by the wall face of the receiving space 50 inside of the upper case, thereby providing a stable circuit shut-off capability.

The receiving space 50 is formed in the center of the upper case and supports the off-set force caused by the connection force of the elastic terminal to thereby enable the ceramic element to remain upright. That is, the ceramic element is accommodated inside of the upper case and remains upright. The receiving space 50 is formed integrally with the upper case through an injection molding process.

The insulator 51 is mounted in the center of the upper case 30 and supports an off-set force by the contact force of the elastic terminal 60 to thereby enable the ceramic element 40 to remain upright. The insulator 50 is most preferred to be made of mica plate, but may be formed of a material having an insulation property such as plastic materials to allow the ceramic element to be upright.

The elastic terminal 60 is formed so as to contact with both sides of the ceramic element 40 and so as not to face each other. The elastic terminal 60 is connected with the tab terminal 70 by means of a rivet 72 or welding and thus a cut-off is derived by an excessive thermal stress or an excessive current to thereby prevent a secondary propagation. Here, the elastic terminal 60 is most preferred to be made of a stainless steel, but may be formed of a copper-base metallic material such as bronze and brass. In addition, the elastic terminal 60 is provided with an embossing to reinforce the elasticity to the material of the elastic terminal 60, thereby enabling to be replaced with a thinner elastic terminal. Furthermore, although not illustrated in the elastic terminal 60, the elastic terminal 60 connected to the tab terminal 70 may be provided with a structurally weak portion at one side thereof to provide a fuse function, which is cut-off when an excessive current is introduced. The weak portion has most preferably an angular shape or a circular shape, but which may be modified in various forms when necessary.

The tab terminal 70 is mounted inside of the upper case 30 and connected with the elastic terminal 60 by means of a rivet 72 or welding to supply electric power.

Therefore, when an unsustainable force is applied to the ceramic element by an excessive thermal stress or an excessive current caused by an external abnormal power supply is applied to the ceramic element, the ceramic element performs an immediate failure and thus a rapid cut-off capability of circuit. The insulator supports an off-set force by a connection force of the elastic terminal to allow the ceramic element to remain upright. The elastic terminal is supported. A case protrusion is formed at both lower portions of the upper case to which the ceramic element is mounted, thereby providing a gradient to allow the ceramic element to remain upright. The elasticity of the elastic terminal material is reinforced, thereby enabling to be replaced by a thinner elastic terminal and thus reduce the manufacturing cost. Even after the operation of the safety device, the scattered ceramic element is captured by the wall face of the receiving space inside of the upper case, thereby providing a capability of stable circuit cut-off.

The above-described characteristics of a positive temperature coefficient thermistor is applied to a heating element of a car pre-heater, an electric heater, a leisure warm air blower, a home bidet, a hot water supplier, an air conditioner, a refrigerator, an auxiliary heat, and the like to achieve an ideal efficiency.

### INDUSTRIAL APPLICABILITY

As described above, in the present invention, an angle is formed such that elastic terminals contacted at both faces of the ceramic element do not face each other and an elastic terminal of one lateral face of the ceramic element is formed without one leg so as not to be contacted with the ceramic element, and therefore when an unsustainable force is applied to the ceramic element by an excessive thermal stress or an excessive current caused by an external abnormal power supply is applied to the ceramic element, the ceramic element performs an immediate failure and thus a rapid cut-off capability of circuit. The upper case is provided with a receiving space for accommodating a ceramic element such that the ceramic element remains upright inside of the receiving space, or the ceramic element is mounted inside of an insulator such that the insulator supports an off-set force by a connection force of the elastic terminal to allow the ceramic element to remain upright. A wedge is formed integrally with the upper case so as to be contacted with the elastic terminal mounted at both sides of the upper case, which supports the elastic terminal, thereby supporting the elastic terminal. Even after the operation of the safety device, the scattered ceramic element is captured by the wall face of the receiving space inside of the upper case, thereby providing a capability of stable circuit cut-off. A case protrusion is formed at both lower portions of the upper case to which the ceramic element is mounted, thereby providing a gradient to allow the ceramic element to remain upright. The tab terminal and the elastic terminal are connected by means of a rivet or welding, and the elastic terminal is provided with an embossing to reinforce the elasticity of the elastic terminal material, thereby enabling to be replaced by a thinner elastic terminal and thus reduce the manufacturing cost.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. A safety device for preventing propagation when a ceramic element is failed, the safety device comprising:
an upper case having a wedge integrally formed for being contacted with an elastic terminal and providing a fixed support, the upper case being equipped with a ceramic element, a tap terminal and an elastic terminal and connected with a lower case;
a receiving space formed in the center of the upper case and supporting an off-set force by a contact force of the elastic terminal so as to enable the ceramic element to remain upright;
a ceramic element mounted inside of the receiving space, wherein, when an unsustainable force is applied by an excessive thermal stress or an excessive current caused by an external abnormal power supply, the ceramic element is derived to be easily fractured, and a conductive material is coated at both faces thereof to form an electrode to which the elastic terminal is contacted, the ceramic element having an exothermic characteristic;
an elastic terminal contacted with both faces of the ceramic element and formed so as not to face each other, the elastic terminal being connected with the tap terminal through a rivet or welding to enable the ceramic element to be fractured by an excessive thermal stress or an excessive current;
a tab terminal mounted inside of the upper case and connected with the elastic terminal through a rivet or welding to enable to supply power; and
a lower case connected with the upper case using a terminal hole, the terminal hole being formed in a position abutting on the tab terminal mounted inside of the upper case.

2. The safety device according to claim 1, wherein the ceramic element includes a positive temperature coefficient thermistor that is heated by application of electricity.

3. The safety device according to claim 1, wherein a receiving space is formed inside of and integrally with the upper case through an injection molding so as to receive the ceramic element at upright state.

4. The safety device according to claim 1, wherein the elastic terminal is formed with an embossing to reinforce the elasticity of elastic terminal material and thus enable to be replaced by a thinner elastic terminal.

5. The safety device according to claim 1, further comprising a case protrusion formed in the lower end of the lower case, which has a gradient provided such that the ceramic element is inserted and remains upright.

6. The safety device according to claim 1, further comprising an insulator so as to allow the ceramic element upright.
